(19) United States
(12) Patent Application Publication
(10) Pub. No.: US 2005/0104871 A1
(43) Pub. Date: May 19, 2005

(54) Computer input device

(76) Inventors: Qing Liu, Fairlawn, NJ (US); Qingde Liu, Paramus, NJ (US)

Correspondence Address: QING LIU, 38 SOUTH BROADWAY, FAIRLAWN, NJ, 07410, US

(21) Appl. No.: 10/714,104

(22) Filed: Nov. 15, 2003

(51) Int. Cl. G09G 5/00

(52) U.S. Cl. 345/179

(57) ABSTRACT

The present invention provides an improved computer input device having one, two, or three buttons like a conventional computer mouse. The direction and amount of movement of this input device is determined by processing the images of a work surface under the computer input device, and this information is used to control a cursor on a computer screen. One tip being located at one end of the input device is attached to a switch. A “click button” signal is generated when a user's hand holding the input device depresses and releases the input device against a work surface. One or two other buttons and a wheel may be included on the body of the input device and can be operated by a user's index finger or thumb.

### BACK GROUND OF THE INVENTION

The present invention relates to a computer input device for positioning a cursor on a computer screen by the movement of a pen-like optical input device on a work surface. The function of this input device is to replace conventional computer mouse.

The generally known computer mouse has certain drawbacks. After extended usage of the conventional computer mouse, it gives rise to pain in fingers and wrists. Moreover, the conventional computer mouse requires some space available within the range of the computer user. Another requirement for the substrate of the mouse is that it must be a firm and plane as well as essentially horizontal substrate of a certain extent to enable the user to orient the screen projection of the mouse relative to the entire extent of the computer screen. It may sometimes be difficult or even impossible to place the computer such that the space required for the operation of the mouse is always available. In addition, one is required to move his arm on order to move a cursor on a computer screen using a conventional computer mouse. This requirement created some difficulties in using a conventional computer mouse for some junior and senior users because of the difficulties to accurately control their arm movement. Fingers are more appropriate to control a cursor on a computer screen since they have been well trained to write and to draw for years when one was in school.

To overcome the drawbacks of a conventional mouse, many attempts have been made for an optical pen-like computer mouse without mechanically moving parts. Such pen-like computer mouse will be extremely convenient, more precise and easy to operate, and being possible to utilize the fact that the fine motor function of the fingers is considerably better developed than that of the arms. Unfortunately, most of them will only work on a pre-designed work surface, such as a tablet, or a pad of particular type. This limitation greatly restricted the usage of these devices. There is one application of U.S. Pat. No. 6,151,015 for a pen-like computer input device working on non-specific surfaces by using image processing to generate the mouse movement signal. But such a computer input device requires a particular shape of a tapering end of the body and also requires the tapering end of the body to be translucent for imaging the underneath work surface area. This requirement makes the invention impractical because the user's fingers and thumb may block the light path while holding the input device. And therefore the images of the underneath work surface area around the tip may not be acquired properly and processed correctly.

In an optical computer input device, the motion detection, by using image processing, is a sophisticated technology. The movement of the input device is detected optically by directly imaging, as an array of pixels, the various particular spatial features of a work surface, much as human vision is believed to do. In general, this work surface may be almost any flat surface, except a clean mirror surface or other particular types. Motion detection is accomplished by comparing a newly captured image with a previously captured image to ascertain the direction and amount of movement.

### SUMMARY OF THE INVENTION

This present invention provides means for pen-like computer input devices, meaning not only the shape of the body of the input device, but also the method the input device being used. When users use such an input device to move a cursor on a computer screen or click a button, users have the same finger movement as users would have when using a pen to write or to draw on paper.

A preferred embodiment of the invention is shaped like a writing pen. There is one tip located at the end of the input device. A switch is attached to the end of the tip inside the embodiment. This switch is operated by depressing and releasing the input device against a work surface and generates a button “click” signal like clicking a button of a conventional computer mouse. This tip-switch combination functions as a button of a conventional computer mouse. One or two other switches disposed on the body of the input device. One of these switches may also append a wheel controlling a rotation sensor. These switches provide the functions such as the buttons on a conventional computer mouse. In present invention, one or all of these switches coupled with a tip or objects providing means to be operated and to trigger signals are referred as “button” or “buttons” as used for a conventional computer mouse.

A preferred embodiment utilizes an illumination device such as a light emitting diode to directly illuminate the work surface on which the input device is used. One or more such illumination device may be used for this purpose. The work surface image is directly focused onto an optical motion sensor, comprising of an array of photon sensitive pixels and image processing integrated circuit that calculates the necessary information to indicate the motion of the input device. This motion information and the signals from switches and a rotation sensor are relayed to the computer via a wired or wireless link.

### DESCRIPTION OF DRAWINGS

FIG. 1 is a view of an input device according to a preferred embodiment of an input device according to the invention,

FIG. 2 is a schematic view of the end of the input device according to one embodiment of the invention,

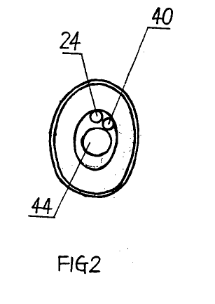

FIG. 3 is a side view of a computer input device,

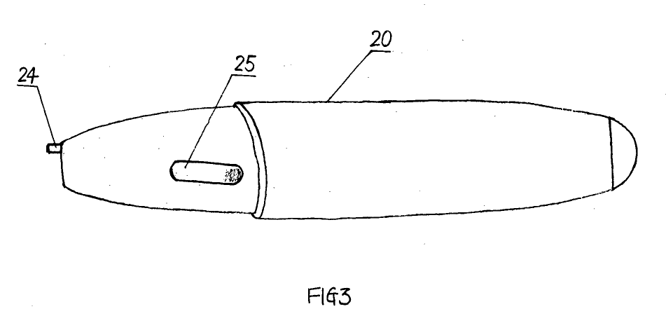

FIG. 4 is another side view of a computer input device,

FIG. 5 is an illustration of a right hand holding a computer input device, each of the index finger and thumb controls a button.

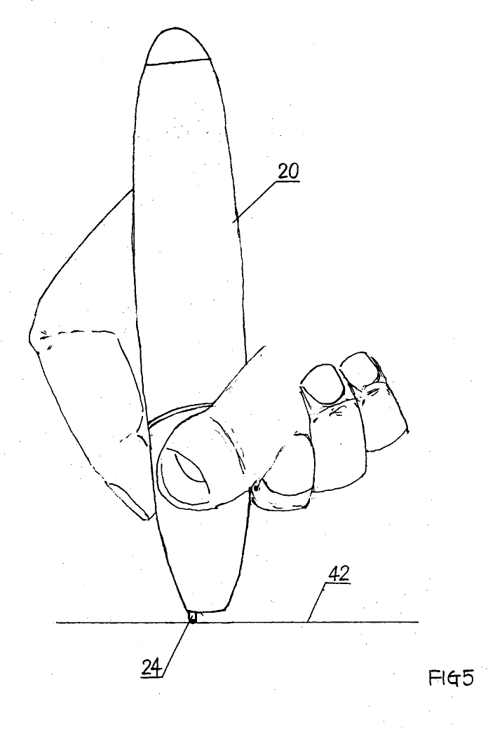

### DETAILED DESCRIPTION OF THE PREFERRED EMBODIMENTS

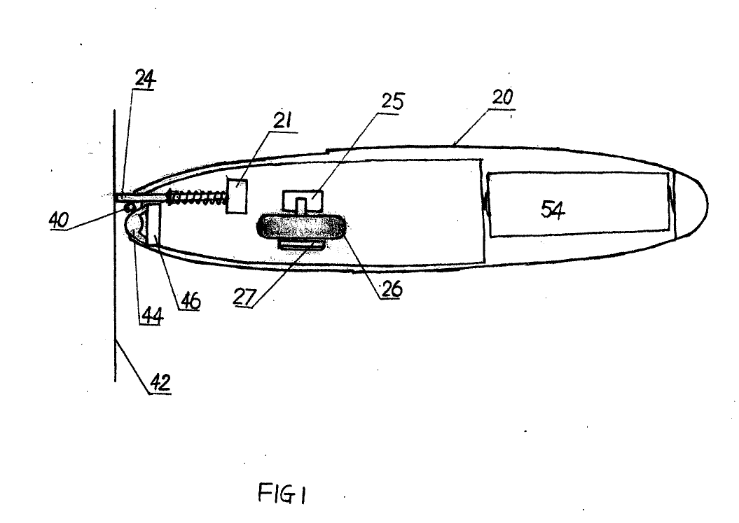

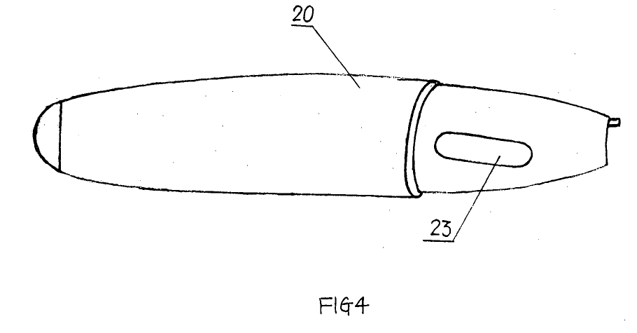

FIG. 1 illustrates the major components of a preferred embodiment of the pen-like computer input device. The body 20 of the input device is generally elliptical or cylindrical. The tip 24 is attached at the end of the body 20. The switch 21 is located at the end of the tip 24. The switches 25 and 23 as shown in FIG. 4 are located on the body 20 of the input device where a user may depress and release them by using index finger and thumb. One of the switches 23 and 25 may append a wheel 26 controlling a rotation sensor 27. Light from the illumination source 40 being located at one end of the body 20 and next to the tip 24 directly illuminates the work surface 42. After light is reflected off the work surface 42, it is focused by lens 44 and constructs an image of the work surface 42. Then this image enters an optical motion sensor integrated circuit (IC) 46. Lens 44 and optical motion sensor IC 46 are also located at the same end of the device's body 20 as the tip 24 and next to tip 24. Optical motion sensor IC 46 has an array of photon sensitive pixels for capturing the image of the work surface 42 and an image processing circuit. Successive images of the work surface 42 are then compared by optical motion sensor IC 46 to determine the forward/backward and left/right motion of the input device.

By holding this input device in hand, like holding a normal pen, a user can move a cursor on a computer screen by moving his fingers only, no arm movement necessary. By depressing and releasing the body 20 against the work surface 42, the tip 24 depresses and releases the switch 21 to generate a mouse button “single click” signal. Repeating such an action in a short time interval generates a mouse button “double click” signal. A user's fingers move the same way when operating such a computer input device, for moving a cursor on a computer screen or clicking a button, as when writing on paper using a normal pen. The operation and function of the switch 21 defines a new and unique controlling mechanism of a button that is different from many other existing applications of such category.

Switch 21, 23, and 25 are not limited to any particular types of switch or switches. Switches 21, 23, and 25 are function based, and can have forms of electrical, mechanical, optical, or any other applicable types to provide a switch function.

The signal of the motion of the input device and the signal from of all buttons (click and/or hold) are coupled to a communication link that sends the motion of the input device and the states of the buttons to the computer. In FIG. 1, the communications link is a radio frequency (RF) wireless transceiver module. However, wired and other wireless communication links may also be used for communication between a computer and the input device. The input device also contains a power source 54. This may be in the form of either rechargeable or non-rechargeable batteries.

Although several embodiments of the invention have been described and illustrated, the invention is not to be limited to the specific forms or arrangements of parts so described and illustrated. The invention is limited only by the claims.

1. A hand held computer input device for a computer or the like, said input device comprising:
a body, said body being generally elliptical or cylindrical;
a switch, said switch being located at one end of said body, said switch being switched on or off by depressing and releasing said input device against a work surface;
an optical motion detection integrated circuit mounted at said end of the body, the motion detection integrated circuit producing motion indication signals indicative of the motion of said input device relative to said work surface.

2. A device as in claim 1, further comprising:
a tip, said tip being located in front of said switch to provide convenience for depressing and releasing.

3. A device as in claim 1, further comprising:
an illumination source, said illumination source being located at said end of the body and providing lights to directly illuminate a work surface.

4. A device as in claim 1, further comprising:
a communication link, said communication link transmitting information representing the motion signal of said input device and buttons' states.

5. A device as in claim 1, further comprising:
one switch, said switch being located on said body, said switch being operated by user's index finger; said switch being coupled to said communication link wherein said communication link transmits information representing the state of said switch.

6. A device as in claim 1, further comprising:
one switch, said switch being located on said body, said switch being operated by user's thumb; said switch being coupled to said communication link wherein said communication link transmits information representing the state of said switch.

7. A device as in claim 5, further comprising:
one rotation sensor operated by a wheel, said rotation sensor and said wheel being located in conjunction with said switch in claim 5; said rotation sensor being coupled to said communication link wherein said communication link transmits information representing the state of said rotation sensor.

8. A device as in claim 6, further comprising:
one rotation sensor operated by a wheel, said rotation sensor and said wheel being located in conjunction with said switch in claim 6; said rotation sensor being coupled to said communication link wherein said communication link transmits information representing the state of said rotation sensor.

9. A device as in claim 4 wherein said communication link is via radio frequency waves.

10. A device as in claim 4 wherein said communication link is via infrared light.

11. A device as in claim 4 wherein said communication link is via conductive wire.
